(19) United States
(12) Patent Application Publication
(10) Pub. No.: US 2010/0320641 A1
(43) Pub. Date: Dec. 23, 2010

(54) PROCESS TO OBTAIN BASIC CONSTRUCTION ELEMENTS FORMED BY CEMENT AND RESIDUAL MATERIAL

(76) Inventors: Cláudio Oliveira Silva, City of Guarulhos (BR); Rafael Giuliano Pileggi, City of Sao Paulo (BR)

Correspondence Address: GREER, BURNS & CRAIN, 300 S WACKER DR, 25TH FLOOR, CHICAGO, IL, 60606, US

(21) Appl. No.: 12/765,495

(22) Filed: Apr. 22, 2010

(30) Foreign Application Priority Data
Apr. 24, 2009 (BR) PI-0900783-0

(51) Int. Cl. B29C 41/02

(52) U.S. Cl. 264/241

(57) ABSTRACT

A process for obtaining basic construction elements formed by cement and residual material for building basic artifacts for civil construction, involving, cement aggregated to mineral residues, the process includes the following steps: accumulation of raw material: formed by cement material found in nature or derived from mining and industrial processes and in this case, there is no single field; homogenization or mixture: is performed manually or by machinery, such as front-end loaders, according to percentage of each raw material used, obtaining an unique and homogenous plaster; disintegration of raw material such as cement, lamination, homogenization, involving specific machinery with a new purge of residual rejects and finally, a temporary bulk storage.

### FIELD OF THE INVENTION

The present patent of invention belongs to the field of civil construction and it refers to a manufacture process of basic elements destined to civil construction such as bricks, tiles, flooring, among others, in which the composing material uses cement, minerals, and cellulosic, natural or residual components still coming from industrial disposal, which replaces with advantage, the regular material of red clay ceramics, since they do not need to go on furnace as clay and do not need to go through drying process in furnaces with high energy cost, among other industrial steps that impair the environment.

### BACKGROUND

The production of basic construction elements, such as blocks with vertical holes, paving stones, tiles, hollows, and flooring, among others, used as formation material, red clay, a notably known material. The processes involved in manufacturing of basic construction elements, listed above in which material is formed from red clay, involve the following steps:
1. Clay extraction from the fields: performed outdoors, using machinery with backhoe or similar equipment. Usually the clay field is next to the company.
2. Clay seasoning: is performed outdoors, in separate lots, according to raw material characteristics, in order to have stability in physicochemical reactions, in a period of three to six months.
3. Raw material stocking: is performed outdoors, in separate lots, according to material's characteristics. In order not to have any water infiltration, these lots must be well-compacted.
4. Homogenization or mixture: is performed manually or with front-end loaders, according to the percentage of each raw material used, resulting in a unique and homogeneous plaster.
5. Mixture box: it is a warehouse with transporting belt with storage capacity for 200 tons, average, of raw material already mixed. The material prepared is protected from bad weather.
6. Mixer: equipment with longitudinal axle that, through propellers in circular movements, allows breaking lumps and plaster homogenization together with mixture water to obtain the right plasticity.
7. Laminator: equipment composed of two cylinders, responsible for clod breaking (lump elimination) and best clay plaster homogenization. This process allows a significant reduction in energy consumption.
8. Extrusion: the homogenized clay gets in the extruder that presses against the mouthpiece (shape), shaping the piece. The air is removed through the vacuum chamber, providing the plaster with cohesion proper to the cut or press in case of tiles.
9. Cut: plaster output from the extruder is cut in the desired length.
10. Pressing: to manufacture tiles, the elements extruded and cut in favorable shape are pressed in a press with matrix that comprise the elements cut providing final shape to the product.
11. Drying: is performed in a covered warehouse containing fixed or mobile shelves, or even, with the material pilled directly in the floor, in order to lose the biggest part of the unit. They remain there for a period of up to six weeks. They are also used by some companies and drying ovens for that purpose, to use the heat coming from furnaces whenever they cool off. The material remains in the drying oven from one to two days. The final desired humidity, is depending on the product, is about 3 to 4%, with a contraction that might vary from 4 to 10%.
12. Burning: the material resulting from the drying process is carried in the furnace. The furnace uses as energy source: wood, sawdust, wood residues, oil or mineral coal. The burning process may last up to one hundred and fifty hours, in virtue of high level of humidity arising from natural drying. The types of furnace used are: regular with variations named as: garrafão, chinês, caipira, paulistinha, etc, and continuous furnace or tunnel furnace, which are considered more advanced in terms of technology, and by the high production that these ones present when compared to regular ones.
13. Inspection or selection: it is performed in the furnace output, rejecting broken, crunched, chipped, over burned and, in case of tiles, the ones emitting inadequate sounds.
14. Storage: it is performed in indoors or outdoors areas, remaining there until shipping.
15. Shipping: effectuated through trucks on roads, using proper or outsourced equipment. Most deliveries are not transported in pallets.

The inconvenience found regarding basic materials for civil construction, are not associated with their application as qualitative technical material since it is professionally accepted and traditionally used as high performance, and low cost, however due to new environmental research and environment preservation policies, it is verified that materials with other compounds, may be used as advantage, because they are now accepted by the consumers and mainly by professionals and sector technicians.

The material called red clay, used in their processing high energy amounts due to drying and burning processes that lately, mean a high cost in manufacture spreadsheet and, on the other hand, before new environmental policies, cause a very expressive impact, showing the need to change paradigms in this sector.

The processes used to build of red traditional ceramics elements, involves completely dispensable steps, regarding the new raw material to be used, i.e., the processes listed below, will not be adopted in the new compound:

a) clay extraction;

b) clay seasoning;

c) mixture box;

d) Drying is transformed in humid cure or vapor; and

e) Burning.

### SUMMARY

It is the object of this patent application, to present a process of cement products production for construction, of low cost for its industrial enforceability, allied to efficiency, economy, safety, and utility practicality requirements offered to consumer public, an additional option for congeners in the market that opposite from processes and traditional products, it is full of innumerous possibilities and benefits, talking about innovation of great expectations and commercial acceptance.

The present manufacture process for construction elements described above, uses a new composition of additives that brings significant advantages regarding production cost and environmental preservation, since the materials used, are technically more efficient in being transformed in industrial processes, in spite of the most elaborated process, in addition to contribute to the environment, due to social environmental values that aggregate, and also, can receive new certificates of quality.

The material developed is a cement-based compound or plaster, aggregated to minerals in recycled natural state, chemical additives and cellulosic.

The plaster resulting from this mixture, can be used to produce basic construction elements, in a traditional red clay factory, already operating, with the advantage to eliminate steps that involve clay extraction and burning, since it is no longer applied to the new material composed.

Due to the analysis of new economical, ecological and technical aspects, in which new material takes favorable status regarding production and commercialization of basic materials for civil construction, led the inventor with notable sector knowledge, to create and develop the subject of the present patent, which conceives a sequence of procedures or process in which a new composition of raw material eliminates a few expensive production steps that also jeopardize the environment.

The differential on a cement-based compound or plaster development is to obtain an economically feasible product and with equal or superior performance when compared to regular products produced in red clay.

Most important properties to be considered regarding a new formation compound are defined as attributes, regarding durability, resistance, water absorption and metric retraction of artifacts.

The elimination of clay extraction steps and its burning process represent a considerable socio-environmental gain related to the red clay sector, because, there is effective reduction in CO₂ emission and improvement of employees' work conditions.

The use of mineral rejects in the composition of innovative raw material, results in advantages also to the mineral sector, in a way to reduce inconveniences in the disposal of material in this segment.

In addition to all advantages mentioned, the formulation of innovative mixture prioritizes the use of mineral residues considered rejects, defined as particulate material arising from ore extraction processes or correlated activities, which contribute to environmental degradation, with high impact in public opinion.

The characterization of this patent request for Invention Privilege proposed herein is made through representative flowcharts of “PROCESS TO OBTAIN BASIC CONSTRUCTION ELEMENTS FORMED BY CEMENT AND RESIDUAL MATERIAL”, in a way, the process can be completely reproduced by proper technique, allowing full characterization of the pleaded object functionality.

From elaborated flowcharts, that show the best way or preferred way to perform the process conceived herein, bases the descriptive part of the report, through a detailed and consecutive numbering that clarifies the aspects that may be implied by the representation adopted, in a way to clearly specify the protection claimed.

Flowcharts are merely illustrative, and may present variation, as long as they do not escape from the required scope.

### BRIEF DESCRIPTION OF THE DRAWINGS

As follows, to best understand the constitution of the “PROCESS TO OBTAIN BASIC CONSTRUCTION ELEMENTS FORMED BY CEMENT AND RESIDUAL MATERIAL,” claimed herein, illustrative designs are enclosed, in which:

FIG. 1. Shows a flowchart of the traditional process to obtain basic elements for construction composed by red clay material, stressing drying and burning steps that spend huge amounts of energy. The arrow lines entering a few flowcharts on the corners indicate the use of manpower and energy spent.

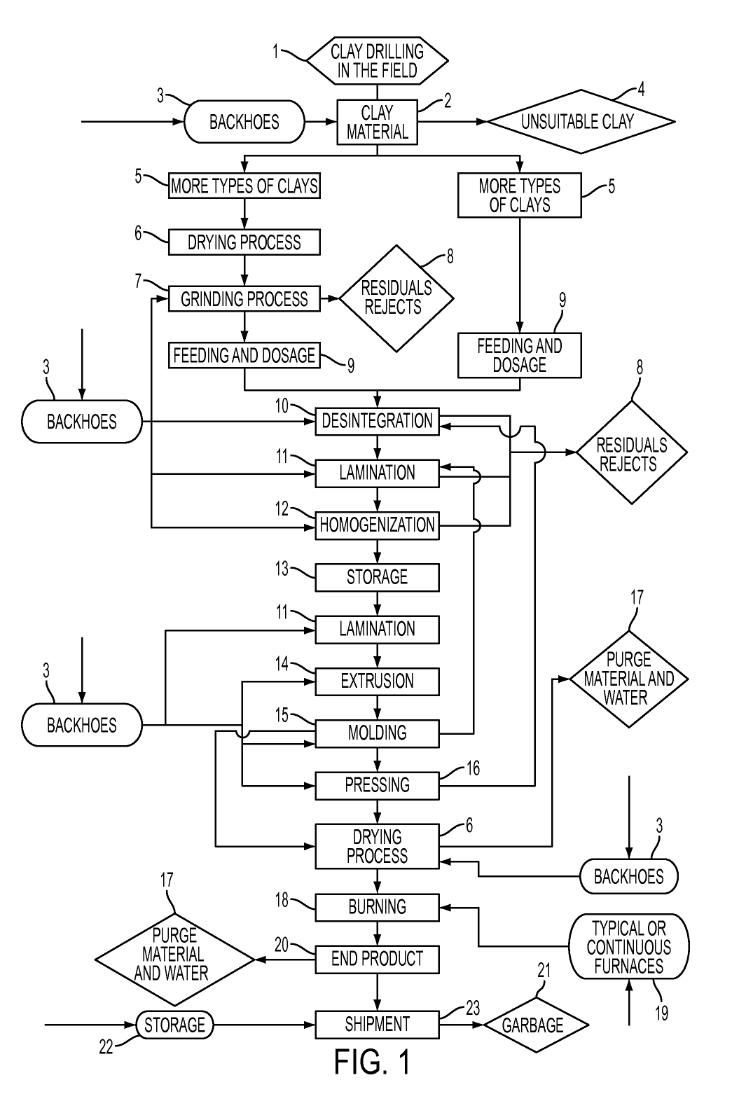

FIG. 2. Shows a process flowchart to obtain basic elements for construction composed by cement and residual material, stressing the absence of drying and burning steps that spend huge amount of energy. The arrow lines entering a few flowcharts on the corners indicate the use of manpower and energy spent.

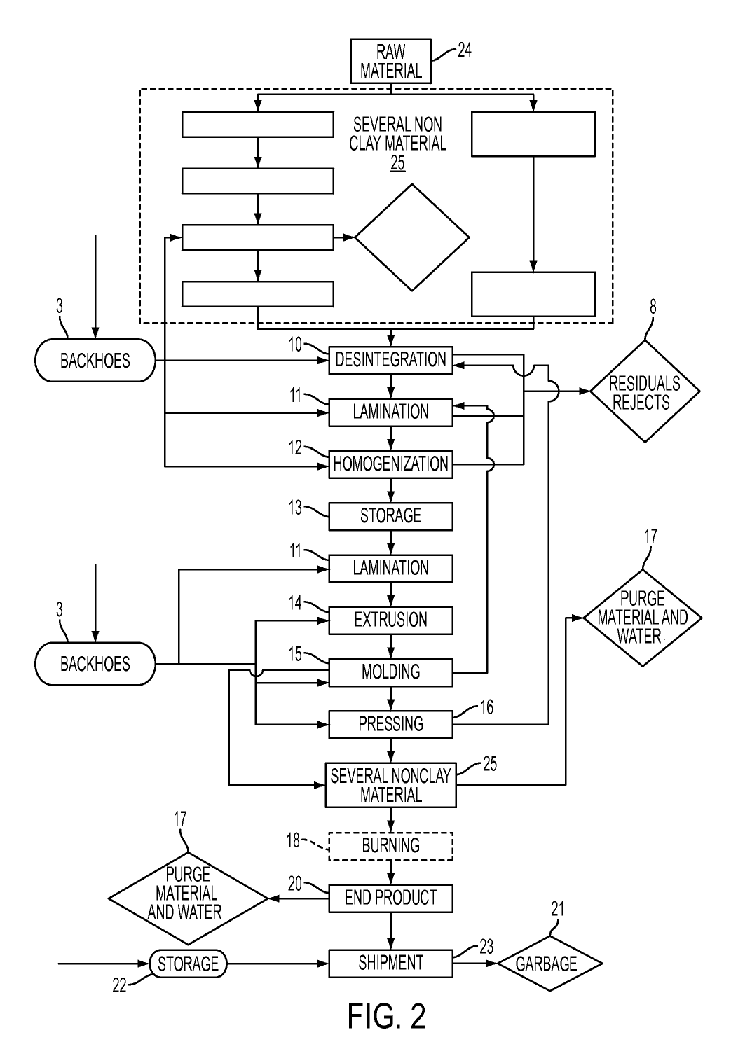

### DETAILED DESCRIPTION

As per illustrated by the aforementioned figures, the “PROCESS TO OBTAIN BASIC CONSTRUCTION ELEMENTS FORMED BY CEMENT AND RESIDUAL MATERIAL”, subject of the present patent, conceives a set of innovative basic elements in civil construction, equivalent to bricks, blocks, tiles and other products, however, produced with cement material aggregated to natural and residuals minerals, providing better physicochemical characteristics.

For a better analysis of differences between the tradition process to manufacture basic construction elements and the new processes to manufacture the same elements, but using the aggregate cement-based, and natural or residual mineral material, it is stipulated the traditional processes, which formation material is red clay, involve the following steps:
a) Clay drilling in the field (1) with extraction of clay material (2), involving machinery (3) such as backhoe or similar equipment, discarding unsuitable clay (4). Usually, clay field is near to the company.
b) Attainment of two or more types of clay (5), in which the primary type, goes through a drying (6), grinding (7) processes, removing residual rejects (8), feeding and dosage (9).
c) Go to the next step, in which the disintegration (10), lamination (11), homogenization (12), of the material is performed involving specific machinery (3) with a new purge of residual rejects (8) and finally, temporary bulk storage (13).
d) Raw material already composed is laminated again (11), to be suitable to the next extrusion step (14), followed by cut, molding (15) and pressing (16). The material, in this step, is eventually, directly pressed (16) after extrusion (14), resulting in a new, already shaped (tile, brick, etc) element. Damaged material at the end of the molding process (15) goes back to the first lamination step (11), therefore, being rejected in the pressing process (16).
e) After obtaining the pieces through the processes described, the drying process is started (6) by means of new machinery (3) insufflators or others, in drying ovens or proper facilities. During the drying process there is purge material and water still (17).
f) After the drying procedure (6) the material is stiffened by the burning process (18) in typical furnaces or continuous (19), from then on the end product is selected (20), from the purged (21) due to crunching or other parameters, in disagreement with the desired quality and, finally, storage (22) forwarded to shipment (23) in order to be marketed.

The processes involved in manufacture of new basic construction elements, previously listed, in which forming material is basically, cement aggregated to mineral residues, involves the following steps:
a) Accumulation of raw material (24): formed by cement material (Cement, Portland, Blast furnace slag, Pozolane, among others), found in nature or derived from mining and industrial processes and in this case there is no single field. Raw material (24) obtained by composition of several non-clay materials is dimensioned, granulated and composed (25) in order to have certain physicochemical characteristics to be able to be transformed in basic construction products.
b) Homogenization (12) or mixture: is performed manually or with machinery (3), such as front-end loaders, according to percentage of each raw material used, obtaining an unique and homogenous plaster.
c) It then, goes to the next step, in which the disintegration (10) of raw material (24) (cement material), lamination (11), homogenization (12), is performed involving specific machinery (3) with a new purge of residual rejects (8) and finally, a temporary bulk storage (13).
d) Already composed raw material (24) is laminated again (11), to be suitable to the next extrusion step (14), followed by cut, molding (15) and pressing (16). The material, in this step, is eventually, directly pressed (16) after extrusion (14), resulting in a new, already shaped (tile, brick, etc) element. Damaged material at the end of the molding process (15) goes back to the first lamination step (11), therefore, being rejected in the pressing process (16).
e) After obtaining the pieces through the processes described, the drying process is started through acclimatization (26) in simple environmental drying ovens and other proper facilities that do not involve machinery (3). In the drying process there is purge (spare) material and water still (17).
f) After the drying procedure through acclimatization (26), the definitive stabilized material, as basic construction piece, does not need to go through the stiffening process through burning (18) in typical or continuous furnace (19), from then on the end product is selected (20), from the purged (21) due to cracking or other parameters, in disagreement with the desired quality and, finally, storage (22) forwarded to shipment (23) in order to be marketed.

The processes involving cement material, to build basic construction pieces do not need field extraction steps (1), induced drying process (6) and do not need the stiffening process through burning process (18) that also involve huge amounts of energy spent, bring relevant energy savings, in addition to significant environmental benefits. The formulation of raw material (24) applied in the process have excellent physical and rheological characteristics, due to the components used and listed below:
Hydraulic agglomeration;
Mineral residues;
Industrial or natural sand;
Plasticizer additives;
Cellulosic additives;
Water.
   The products manufactured with the innovative plaster are produced with the extrusion technique and artifacts are obtained, such as, tiles, paving stones, bricks, blocks, flooring and panels, with or without structural function. The artifacts may be manufactured in most varied dimensions and shapes with the following differentials:
use mineral residues in formulation;
do not contain clay;
do not need to be burned;
   They have mechanical resistance compatible with similar products manufactured from red clay.

The development of cement plaster also requires the attainment of materials proper to extrusion practice, in which density attributes, plasticity among other greatness, must be taken into account. This way, the agglomeration (Cement, Portland, Blast furnace slag, Pozolane, among others) are adjusted for the best performance in the extrusion process. The physicochemical characteristics of natural, industrial aggregated or those arising from residues are adapted to extrusion.

All the development of products and the composition plaster itself is performed by means of rheological assays that help in the attainment of formulations with characteristics proper to the extrusion process in equipment, already used in the production of products from red clay.

This specification referred to a new conception in basic construction material presented as stressed in analysis performed and figures shown, several differences about the conventional models existing in the consumer market, in addition to constructive and functional technical characteristics completely different from the ones pertinent to the state of the art.

Due to privileges offered, and also, due to truly innovative characteristics that fulfill all the requirements of novelty and originality in the genre, the present “PROCESS TO OBTAIN BASIC CONSTRUCTION ELEMENTS FORMED BY CEMENT AND RESIDUAL MATERIAL” gathers necessary and sufficient conditions to earn the Invention Privilege patent.

While a particular embodiment of the present process for obtaining basic construction elements formed by cement and residual material has been described herein, it will be appreciated by those skilled in the art that changes and modifications may be made thereto without departing from the invention in its broader aspects and as set forth in the following claims.

1. A process for obtaining basic construction elements formed by cement and residual material, involved in the manufacture of basic construction elements, in which forming material includes cement aggregated to mineral residues, comprising the following steps:
a) accumulation of raw material: formed by cement material found in nature or derived from mining and industrial processes; the raw material is dimensioned, granulated and composed to present certain specific physicochemical characteristics to be able to be transformed in basic construction products;
b) homogenization or mixture, according to a percentage of each raw material used, obtaining a unique and homogenous plaster;
c) disintegration of raw material, lamination, homogenization, is performed involving specific machinery with a new purge of residual rejects and finally, a temporary bulk storage;
is d) raw material already composed is laminated again, to be suitable to the next extrusion step, followed by cutting, molding and pressing, the material, in this step, is eventually, directly pressed after extrusion, resulting in a new, already shaped element; damaged material at the end of the molding process goes back to the first lamination step, therefore, being rejected in the pressing process;
e) after obtaining the pieces through the processes described, drying is started; and
f) after the drying procedure through acclimatization, the material stabilized in definitive, as basic piece of construction, does not need to go through the stiffening process through burning in typical or continuous furnace, from then on the end product is selected.

2. The process of claim 1 wherein the raw material is obtained from the composition of several nonclay materials.

3. The process of claim 1, wherein the raw material is taken from the group consisting of: Cement, Portland, Blast furnace slag, and Pozolane.

4. The process of claim 1 wherein said homogenization is performed manually or by machinery, such as front-end loaders.

5. The process of claim 1 wherein the drying process is achieved through acclimatization in simple environmental drying ovens and other suitable facilities that are machinery-free.

6. The process of claim 1 wherein in the drying process, purged material and water remains.

7. The process of claim 1 wherein the end product is selected and restricted from material purged due to chucking, in disagreement with the desired quality, and then sent to storage for forwarding to shipment.

8. The process according to claim 1 including a series of process, involved in the manufacture of basic construction elements, and not requiring field extraction, induced drying process and do not need the stiffening procedure through burning steps.
